(19) United States
(12) Patent Application Publication
(10) Pub. No.: US 2025/0224865 A1
(43) Pub. Date: Jul. 10, 2025

(54) FEEDBACK TO IMPROVE MULTIMEDIA CONTENT

(71) Applicant: Capital One Services, LLC, McLean, VA (US)

(72) Inventors: Matthew WALKER, Anna, TX (US); Mohamed SECK, Aubrey, TX (US); Randy RASMUSSEN, Allen, TX (US)

(21) Appl. No.: 18/406,620

(22) Filed: Jan. 8, 2024

(51) Int. Cl. G06F 3/0486; G06F 3/0487; G06F 40/40; G09B 5/06

(52) U.S. Cl. CPC G06F 3/0486; G06F 3/0487; G09B 5/065; G06F 40/40

(57) ABSTRACT

In some implementations, a multimedia host may stream multimedia content to a user device, where a current timestamp associated with the multimedia content is tracked. The multimedia host may receive, from the user device, an indication of an interaction, where the interaction is associated with the current timestamp and a portion of a pixel space of the multimedia content. The multimedia host may receive, from the user device, text provided by a user of the user device and may provide the text to a machine learning model to receive an indication of a proposed change to the multimedia content. The multimedia host may transmit, to a ticket system, a command to open a ticket including the text and the proposed change.

### BACKGROUND

Multimedia content can be an important tool for training, whether formally in an organization or informally for do-it-yourself projects. Users that consume multimedia content may send feedback to creators of the multimedia content. However, processing, filtering, and summarizing the feedback may consume power and processing resources at the creators' devices.

### SUMMARY

Some implementations described herein relate to a system for gathering and assessing feedback on multimedia content. The system may include one or more memories and one or more processors communicatively coupled to the one or more memories. The one or more processors may be configured to stream the multimedia content to a user device, wherein a current timestamp associated with the multimedia content is tracked. The one or more processors may be configured to receive, from the user device, an indication of an interaction, wherein the interaction is associated with the current timestamp and a portion of a pixel space of the multimedia content. The one or more processors may be configured to receive, from the user device, text provided by a user of the user device. The one or more processors may be configured to provide the text to a machine learning model to receive an indication of a proposed change to the multimedia content. The one or more processors may be configured to transmit, to a ticket system, a command to open a ticket including the text and the proposed change.

Some implementations described herein relate to a method of gathering and assessing feedback on multimedia content. The method may include streaming, from a multimedia host and to a user device, the multimedia content, wherein a current timestamp associated with the multimedia content is tracked. The method may include receiving, at the multimedia host and from the user device, an indication of an interaction, wherein the interaction is associated with the current timestamp and a portion of a pixel space of the multimedia content. The method may include receiving, at the multimedia host and from the user device, text provided by a user of the user device. The method may include providing, by the multimedia host, the text to a machine learning model to cluster the text with additional feedback provided by one or more additional users. The method may include transmitting, from the multimedia host and to an administrator device, an indication of the text and the additional feedback.

Some implementations described herein relate to a non-transitory computer-readable medium that stores a set of instructions for providing feedback on multimedia content. The set of instructions, when executed by one or more processors of a device, may cause the device to receive the multimedia content from a multimedia host. The set of instructions, when executed by one or more processors of the device, may cause the device to detect an interaction with the multimedia content. The set of instructions, when executed by one or more processors of the device, may cause the device to record a current timestamp and a portion of a pixel space of the multimedia content associated with the interaction. The set of instructions, when executed by one or more processors of the device, may cause the device to output an input element in response to the interaction. The set of instructions, when executed by one or more processors of the device, may cause the device to receive text provided by a user of the device. The set of instructions, when executed by one or more processors of the device, may cause the device to hide the input element in response to receiving the text. The set of instructions, when executed by one or more processors of the device, may cause the device to transmit the text, with an indication of the current timestamp and an indication of the portion of the pixel space, to the multimedia host.

### BRIEF DESCRIPTION OF THE DRAWINGS

FIGS. 1A-1G are diagrams of an example implementation relating to feedback to improve multimedia content, in accordance with some embodiments of the present disclosure.

FIGS. 2A-2C are diagrams of a series of example user interfaces associated with feedback on multimedia content, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to receiving feedback to improve multimedia content, in accordance with some embodiments of the present disclosure.

FIG. 6 is a flowchart of an example process relating to providing feedback to improve multimedia content, in accordance with some embodiments of the present disclosure.

### DETAILED DESCRIPTION

The following detailed description of example implementations refers to the accompanying drawings. The same reference numbers in different drawings may identify the same or similar elements.

Multimedia content can be an important tool for training, whether formally in an organization or informally for do-it-yourself projects. For example, a user may proceed through a series of training videos. The user may choose to send feedback to a creator of the training videos. However, processing, filtering, and summarizing the feedback may consume power and processing resources at the creator's device.

Additionally, different feedback may be associated with different portions of the training videos. Accordingly, identifying relevant portions of the training videos to modify can consume additional power and processing resources at the creator's device.

Some implementations described herein enable receiving and processing real-time feedback on multimedia content. The feedback may be recorded along with a current timestamp and an indication of a portion of a pixel space of the multimedia content. As a result, the feedback is more actionable. Additionally, the feedback may be automatically transmitted to a creator's device and/or transmitted to a ticket system. As a result, computer resources (e.g., power and/or processing resources) are saved as compared with storing the feedback for later retrieval, filtering, and summarizing.

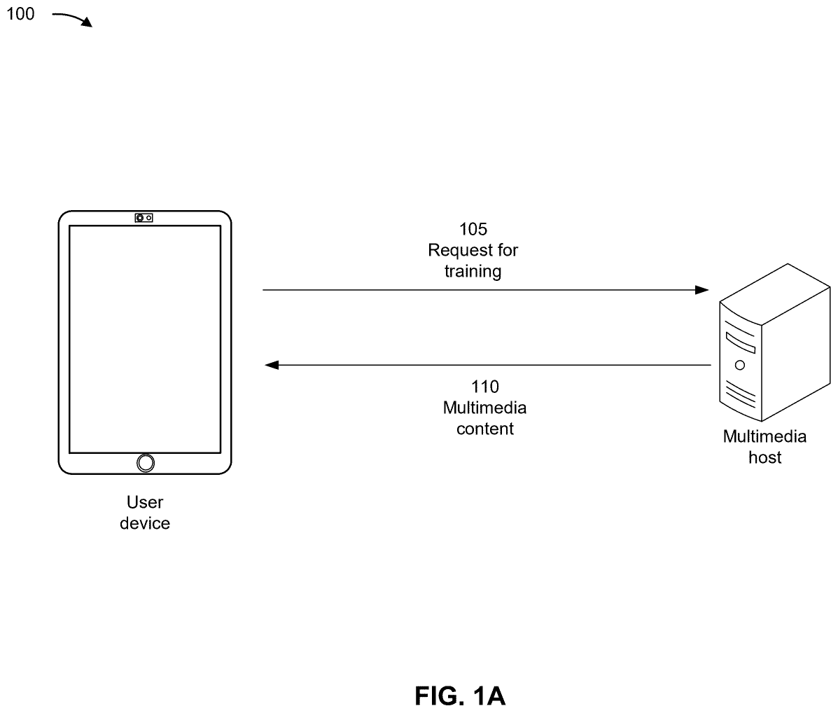

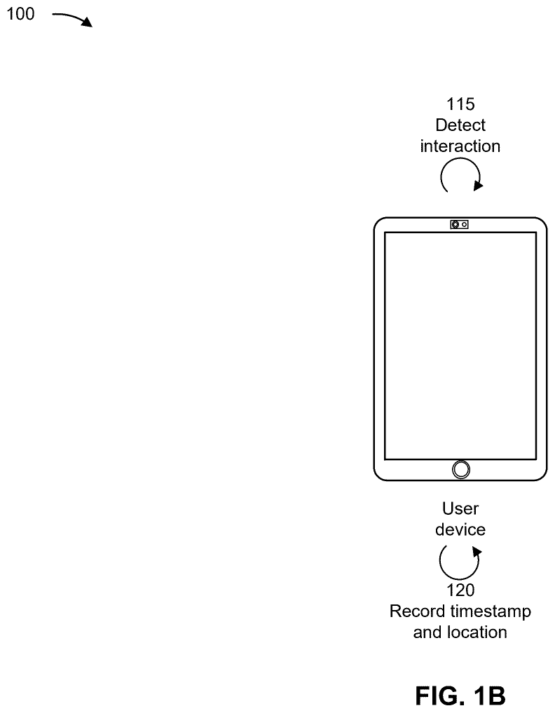

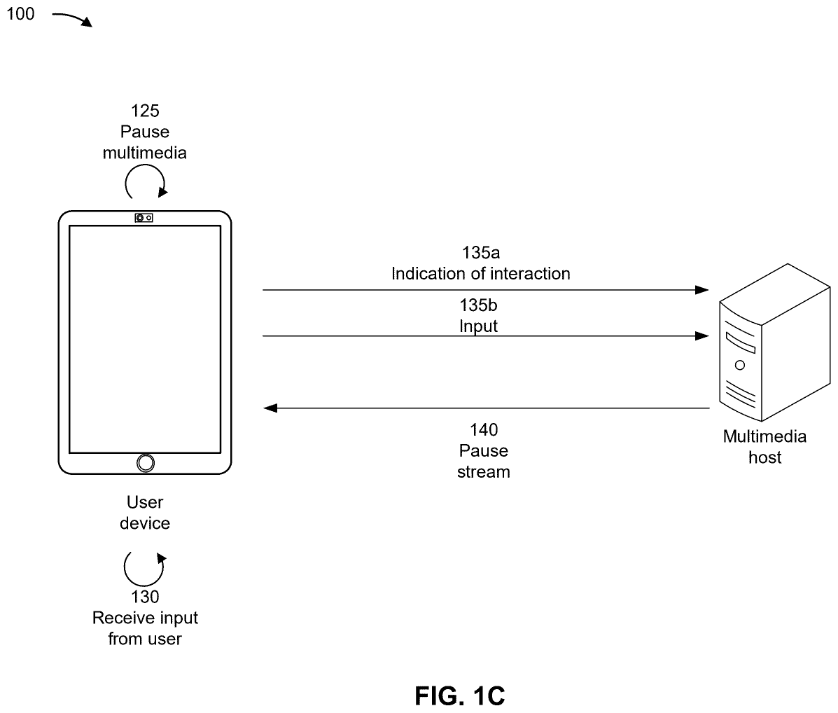

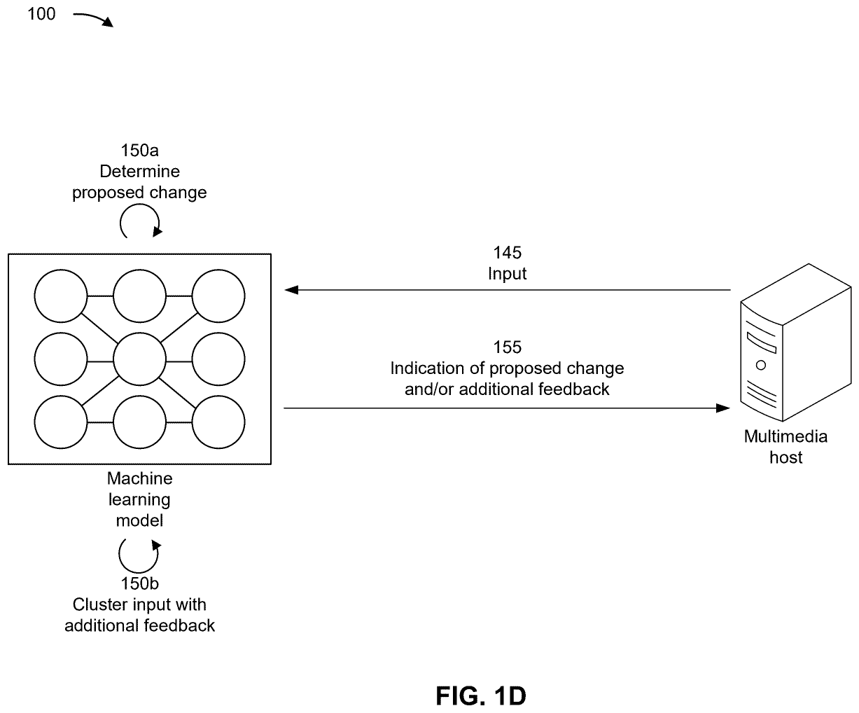

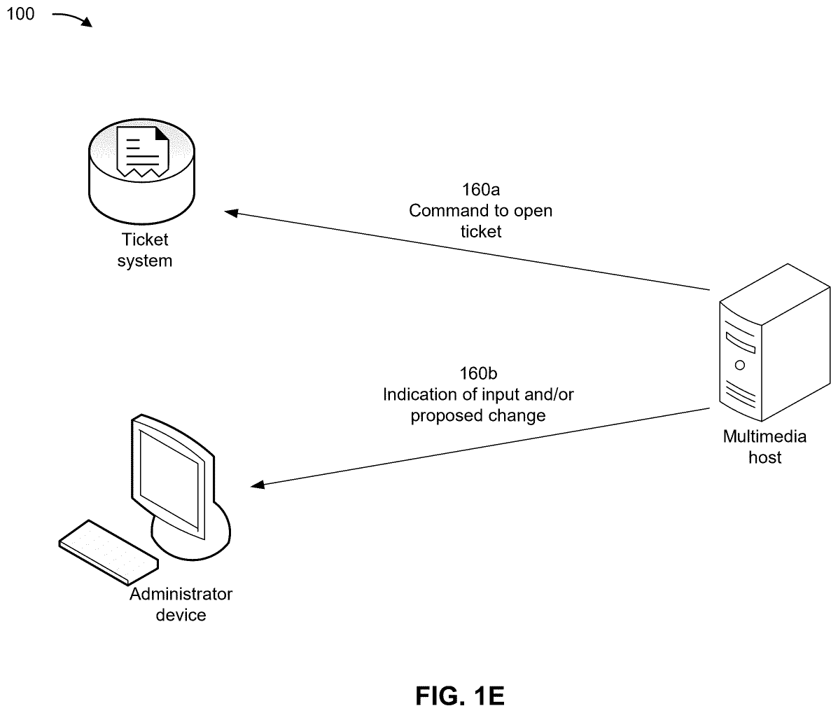

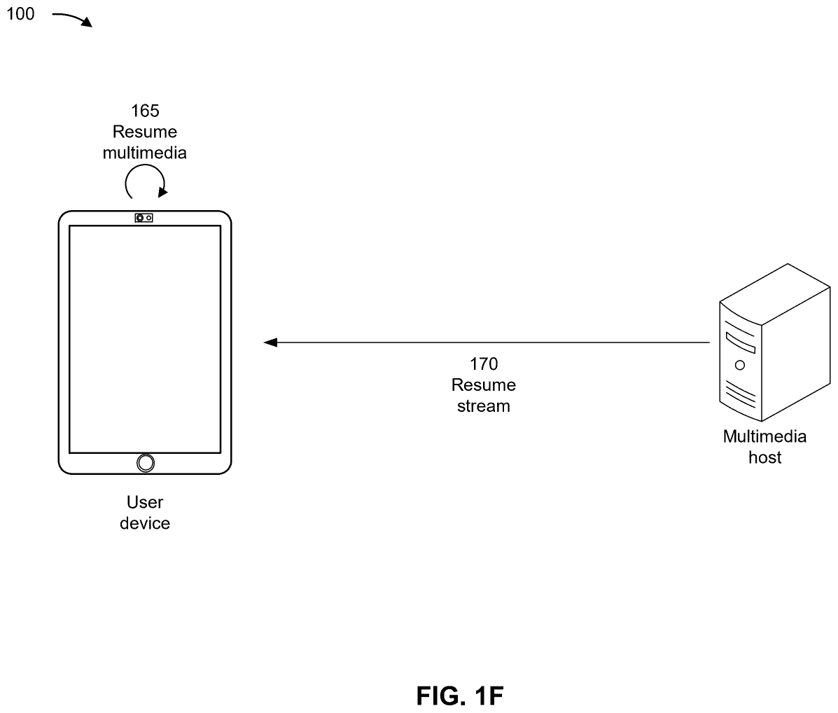

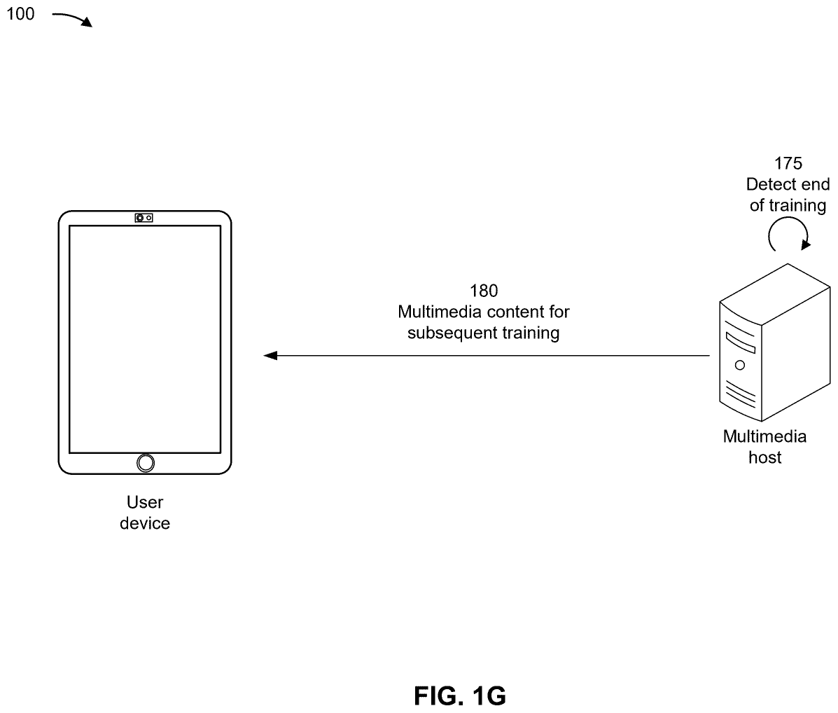

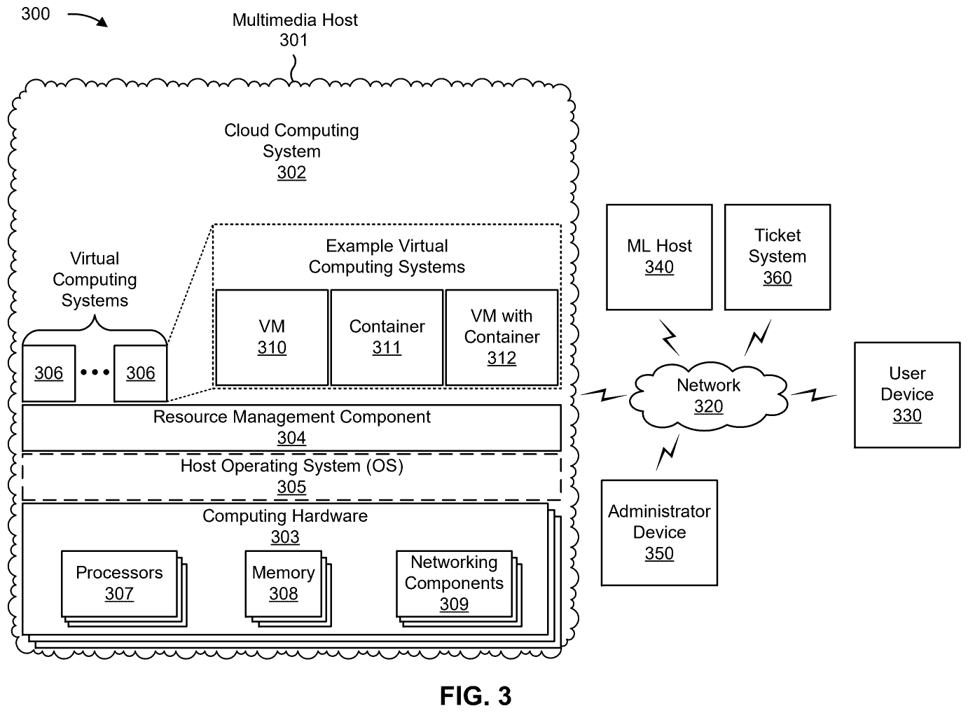

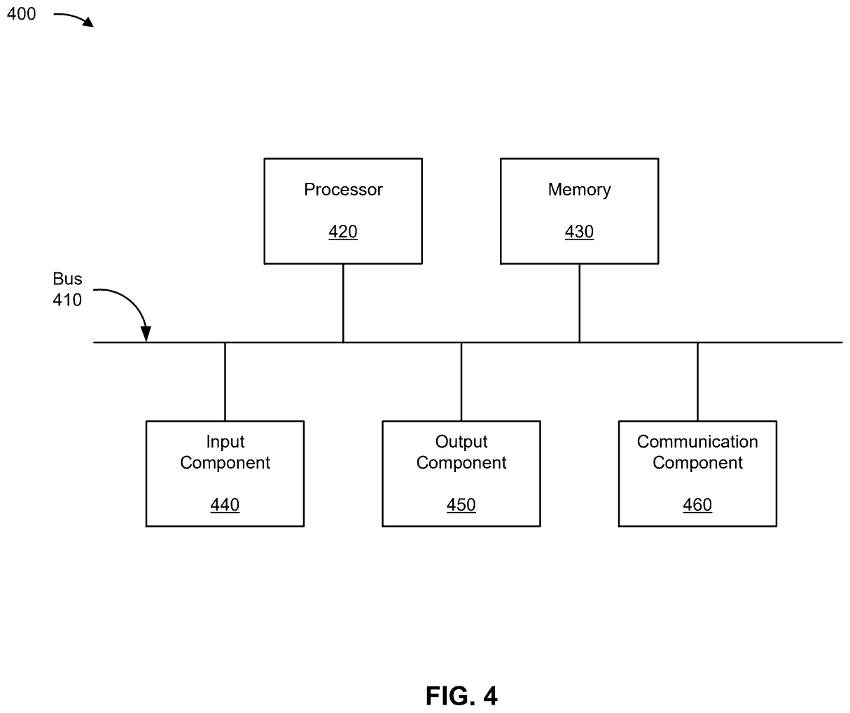

FIGS. 1A-1G are diagrams of an example 100 associated with feedback to improve multimedia content. As shown in FIGS. 1A-1G, example 100 includes a user device, a multimedia host, a machine learning (ML) model (e.g., provided by an ML host), a ticket system, and an administrator device. These devices are described in more detail in connection with FIGS. 3 and 4.

As shown in FIG. 1A and by reference number 105, the user device may transmit, and the multimedia host may receive, a request for multimedia content. The request may include a hypertext transfer protocol (HTTP) request, a file transfer protocol (FTP) request, and/or an application programming interface (API) call. The request may include (e.g., in a header and/or as an argument) an indication of the multimedia content. For example, the indication of the multimedia content may include an alphanumeric identifier (e.g., included in, or derived from, a slug of a uniform resource locator (URL) associated with the multimedia content).

In some implementations, a user of the user device may provide input (e.g., using an input component of the user device) that triggers the user device to transmit the request. For example, a web browser (or another type of application executed by the user device) may navigate to a website hosted by (or at least associated with) the multimedia host and provide a user interface (UI) to the user (e.g., using an output component of the user device). Accordingly, the user may interact with the UI to trigger the user device to transmit the request. Additionally, or alternatively, the user device may transmit the request automatically. For example, the user device may detect an end of a previous training and transmit the request in response to the end of the previous training. Accordingly, the multimedia content may be an upcoming training (e.g., that follows in sequence after the previous training).

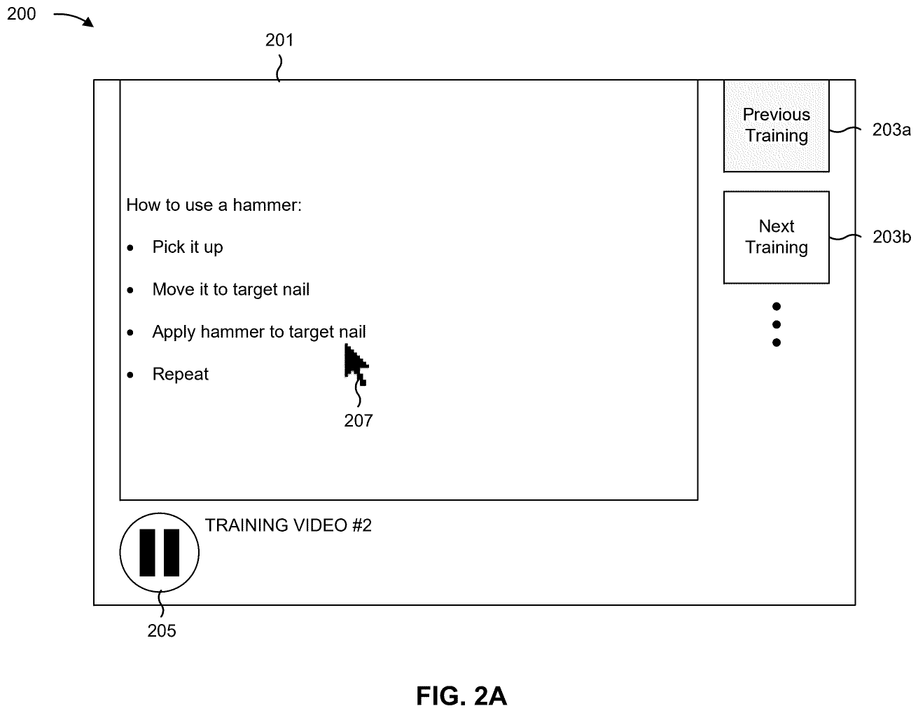

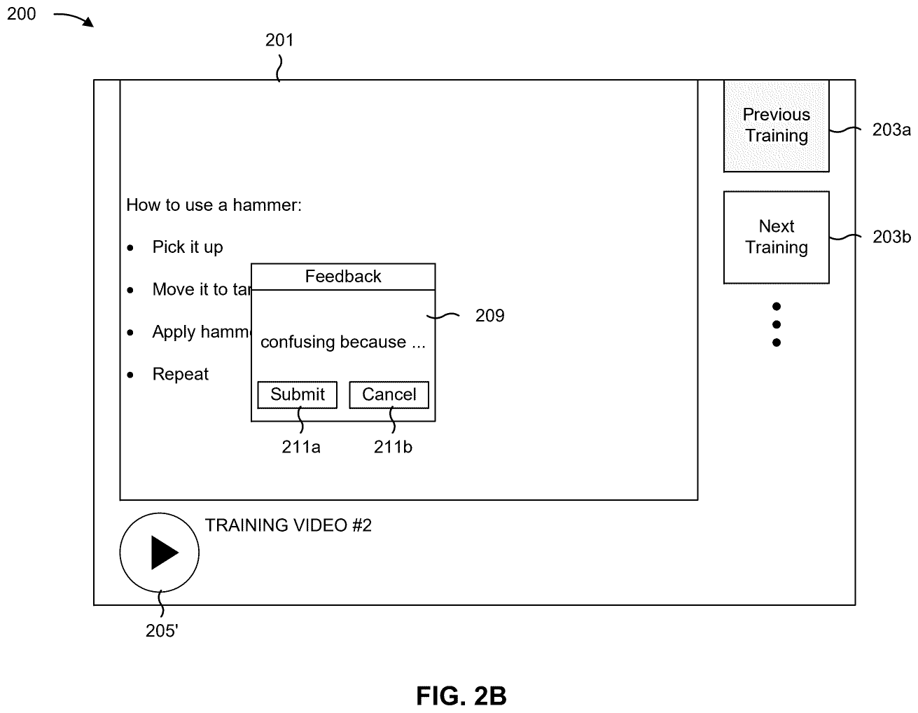

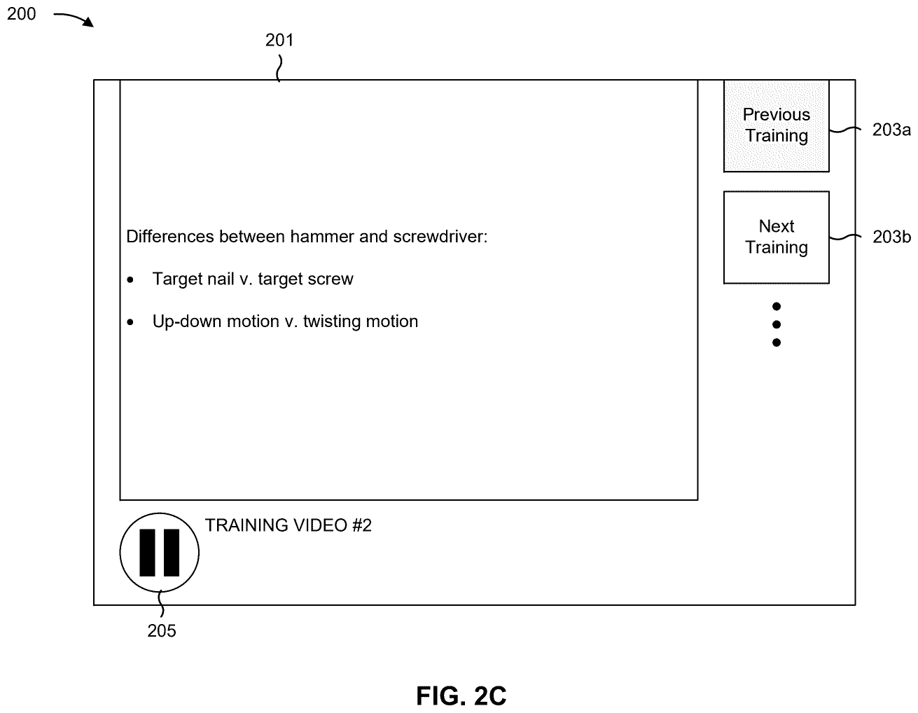

As shown by reference number 110, the multimedia host may stream, and the user device may receive, the multimedia content. The multimedia host may stream the multimedia content in response to the request from the user device. In some implementations, the multimedia host may use a real time streaming protocol (RTSP), a real-time transport protocol (RTP), and/or a real-time transport control protocol (RTCP) to stream the multimedia content. Other protocols may include a transmission control protocol (TCP) and/or a real-time messaging protocol (RTMP), among other examples. Accordingly, the multimedia content may be delivered by the multimedia host and consumed by the user device in a relatively continuous manner, with little or no intermediate storage in network components (although the user device may buffer ahead to reduce latency). The user device may output the multimedia content to a UI that includes a frame for the multimedia content, as described in connection with FIGS. 2A-2C.

Although the example 100 is described in connection with the user device requesting the multimedia content, other examples may include the multimedia host automatically streaming the multimedia content to the user device. For example, the multimedia host may detect an end of a previous training and stream the multimedia content in response to the end of the previous training. Accordingly, the multimedia content may be an upcoming training (e.g., that follows in sequence after the previous training).

The multimedia host may track a current timestamp associated with the multimedia content while streaming the multimedia content. In one example, the multimedia host may track a timestamp associated with a packet (encoding a portion of the multimedia content) being transmitted to the user device (e.g., by virtue of being a next packet in a buffer to transmit to the user device). In some implementations, the multimedia host may perform an adjustment to the timestamp associated with the packet to determine the current timestamp. For example, the multimedia host may estimate a latency associated with a connection between the multimedia host and the user device and subtract the latency from the timestamp associated with the packet to calculate the current timestamp. Additionally, or alternatively, the multimedia host may receive an indication from the user device, and the current timestamp may be determined based on the indication. For example, the user device may indicate the current timestamp. Alternatively, the user device may indicate a most recently decoded packet, and the multimedia host may determine the current timestamp as a timestamp associated with the most recently decoded packet.

Additionally, or alternatively, the user device may track a current timestamp associated with the multimedia content while outputting the multimedia content (e.g., to the user via an output component of the user device). For example, the user device may identify a most recently decoded packet from the multimedia host, and the user device may determine the current timestamp as a timestamp associated with the most recently decoded packet.

As shown in FIG. 1B and by reference number 115, the user device may detect an interaction with the multimedia content. For example, the interaction may include a left-click or a right-click on a portion of a pixel space of the multimedia content (e.g., a portion of the frame of the UI including the multimedia content). Additionally, or alternatively, the interaction may include a drag-and-drop onto a portion of a pixel space of the multimedia content (e.g., a portion of the frame of the UI including the multimedia content).

As shown by reference number 120, the user device may record the current timestamp and a location associated with the interaction. The location may include a portion of a pixel space of the multimedia content. For example, the user device may record coordinates associated with the interaction (e.g., coordinates at which the user left-clicked, right-clicked, or dropped in a drag-and-drop interaction). Additionally, or alternatively, the user device may translate coordinates associated with the interaction to coordinates within the multimedia content. For example, a pixel position associated with the interaction may correspond to a particular pixel position in the multimedia content (e.g., as rendered in the frame of the UI).

As shown in FIG. 1C and by reference number 125, the user device may pause output of the multimedia content in response to detecting the interaction. For example, the user device may continue to buffer the multimedia content but temporarily store buffered packets rather than decoding the packets and outputting the multimedia content. Accordingly, from the user's perspective, the multimedia content may be paused. Alternatively, the user device may continue outputting the multimedia content after detecting the interaction. Accordingly, from the user's perspective, the multimedia content may continue even while the user provides feedback.

As shown by reference number 130, the user device may receive input (e.g., text) provided by the user. For example, the user may provide the input using an input component of the user device. In some implementations, the user device may output an input element (e.g., a text box) in response to the interaction. For example, as described in connection with FIG. 2B, the user device may add the input element to the UI that includes the multimedia content. Therefore, the user may provide the input using the input element. Furthermore, the user device may hide the input element in response to receiving the input. For example, as described in connection with FIG. 2C, the user device may remove the input element from the UI that includes the multimedia content. The input may include text with feedback on the multimedia content. In particular, the input may include feedback associated with the current timestamp and the location.

As shown by reference number 135a, the user device may transmit, and the multimedia host may receive, an indication of an interaction, the interaction being associated with the current timestamp and the location on the multimedia content. For example, the user device may transmit a message, such as a control message, including the indication. The indication may further encode the current timestamp and the location (e.g., the portion of the pixel space of the multimedia content).

Additionally, as shown by reference number 135b, the user device may transmit, and the multimedia host may receive, the input provided by the user. In some implementations, the input may be included in a same message as the indication of the interaction. Alternatively, the input may be included in a separate message.

Although the example 100 shows the indication of the interaction and the input as transmitted concurrently (or at least adjacent in time), other examples may include a delay. For example, the user device may transmit the indication of the interaction in response to detecting the interaction. Accordingly, while the user provides the input, the multimedia host may pause streaming of the multimedia content, as shown by reference number 140, in response to the indication of the interaction. Therefore, the multimedia host may conserve network resources while the user provides the input. Alternatively, the multimedia host may continue streaming the multimedia content after receiving the indication of the interaction. Subsequently, the user device may transmit the input in response to receiving the input from the user.

As shown in FIG. 1D and by reference number 145, the multimedia host may provide the input to the ML model. For example, the multimedia host may transmit, and the ML host may receive, a request including the input. The ML model may be trained (e.g., by the ML host and/or a device at least partially separate from the ML host) using a labeled set of feedback (e.g., for supervised learning). Additionally, or alternatively, the ML model may be trained using an unlabeled set of feedback (e.g., for deep learning). In one example, the ML model may be configured to suggest proposed changes to the multimedia content based on the input. Additionally, or alternatively, the ML model may be configured to cluster the input with additional feedback provided by additional users (e.g., one or more additional users).

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., feedback from users). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the cloud management device, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 150a, the ML model may determine a proposed change to the multimedia content based on the input. For example, the ML model may suggest a visual, textual, and/or audio change to a particular frame (or set of frames) of the multimedia content based on similar feedback consumed by the ML model. Additionally, or alternatively, as shown by reference number 150b, the ML model may cluster the input with additional feedback provided by additional users. For example, the ML model may cluster the input based on sentiment (e.g., using natural language processing (NLP)) and/or based on content (e.g., using large language models (LLMs)). In some implementations, the ML model may additionally generate a summary of the input with the additional feedback that are grouped in a same cluster. Accordingly, the ML model may summarize a group of feedback that all generally relate to a same portion of the multimedia content.

As shown by reference number 155, the multimedia host may receive, from the ML model, an indication of a proposed change (e.g., as described in connection with reference number 150a) and/or an indication of the additional feedback (e.g., as described in connection with reference number 150b) from the ML model. For example, the ML host may transmit a message including the indications. In some implementations, the multimedia host may additionally receive, from the ML model, an indication of a summary (e.g., of the input and the additional feedback).

Although the example 100 is described in connection with a single ML model (or a single ensemble model), other examples may include multiple ML models. For example, one ML model may generate the proposed change while a separate ML model may cluster the input to determine the additional feedback. Additionally, or alternatively, one ML model may cluster the input to determine the additional feedback while a separate ML model may summarize the input and the additional feedback. Accordingly, the multiple ML models may be provide by a single ML host or a plurality of ML hosts. Therefore, in some implementations, the multimedia host may transmit different requests to different ML host.

As shown in FIG. 1E and by reference number 160a, the multimedia host may transmit, and the ticket system may receive, a command to open a ticket including the input and the proposed change. The ticket may be associated with the multimedia content (e.g., indicating the multimedia content via a title and/or another type of identifier). The multimedia host may further indicate a corresponding administrator (associated with the multimedia content) in the command such that the ticket tags the corresponding administrator. For example, the multimedia host may determine, using a data structure mapping (i.e., that maps) multimedia identifiers to user identifiers, the corresponding administrator associated with the multimedia content. For example, the multimedia host may map a string representing the multimedia content (e.g., a title of the multimedia content) to a string representing the corresponding administrator (e.g., a name of the administrator, a username, and/or an email address, among other examples).

In some implementations, the multimedia host may include an email address, associated with the corresponding user, in the command. Accordingly, the ticket system may transmit communications, associated with the ticket, to the email address. The email address may be indicated in the data structure. Alternatively, the multimedia host may determine the email address from a database storing a contact list or another similar type of data structure. The database may be implemented in a local storage (e.g., a memory managed by the multimedia host) or in a storage that is at least partially separate (e.g., physically, logically, and/or virtually) from the multimedia host. Therefore, the multimedia host may transmit a query to the database (e.g., included in an HTTP request and/or using an API call) and receive a response to the query (e.g., included in an HTTP response and/or as a return from the API call) that includes the email address.

Additionally, or alternatively, as shown by reference number 160b, the multimedia host may transmit, and the administrator device may receive, an indication (e.g., one or more indications) of the proposed change, the input, the additional feedback, and/or the summary. For example, the multimedia host may transmit the indication in an email message to an email address associated with the administrator device.

As shown in FIG. 1F and by reference number 165, the user device may resume streaming of the multimedia content. For example, the user device may resume streaming in response to the input from the user. Accordingly, the user device may resume streaming while the multimedia host processes the input. In some implementations, as shown by reference number 170, the multimedia host may continue streaming the multimedia content in response to the input from the user device. Accordingly, the multimedia host may resume streaming concurrently with processing the input.

As described above, the multimedia content may be a training. Accordingly, as shown in FIG. 1G and by reference number 175, the multimedia host may detect an end of the multimedia content and thus an end of the training. Accordingly, as shown by reference number 180, the multimedia host may automatically stream a subsequent training (e.g., that follows in sequence after the multimedia content) in response to the end of the multimedia content.

By using techniques as described in connection with FIGS. 1A-1G, the multimedia host receives feedback on the multimedia content along with the current timestamp and an indication of the location on multimedia content. As a result, the feedback is more actionable (e.g., by an administrator after receiving a notification from the ticket system and/or at the administrator device). Additionally, the multimedia host conserves computer resources as compared with storing the feedback for later retrieval, filtering, and summarizing.

As indicated above, FIGS. 1A-1G are provided as an example. Other examples may differ from what is described with regard to FIGS. 1A-1G.

FIGS. 2A-2C are diagrams of a series 200 of example UIs associated with feedback on multimedia content. The example UIs shown in FIGS. 2A-2C may be output by a user device based on instructions from a multimedia host. These devices are described in more detail in connection with FIGS. 3 and 4.

As shown in FIG. 2A, an example UI may include a frame 201 for multimedia content. The multimedia content may be a training, and thus the example UI may include navigational elements associated with other trainings (e.g., element 203a associated with a previous training and element 203b associated with a subsequent training, as shown in FIG. 2A). Additionally, the example UI may include an element 205 that controls the multimedia content. In FIG. 2A, the multimedia content is playing, so the element 205 allows a user to pause the multimedia content.

As further shown in FIG. 2A, the user may interact using a left-click or a right-click (e.g., using a mouse, a touchscreen, or a microphone) to record a current timestamp and a location associated with cursor 207. In other words, the user may use the interaction to signal a desire to provide feedback associated with the current timestamp and the location on the multimedia media indicated by the cursor 207.

As shown in FIG. 2B, an input element 209 is shown. The input element 209 may be generated in response to the interaction. The input element 209 may include a text box for the user to provide feedback (in the form of text). Additionally, a button 211a may be shown that triggers transmission of the feedback to the multimedia host, and a button 211b may be shown that cancels the feedback (e.g., discards any text entered into the input element 209).

As further shown in FIG. 2B, the multimedia content has been paused to allow the user to provide the feedback. Therefore, the element 205 has changed into element 205′ that allows the user to resume the multimedia content (e.g., even while providing the feedback).

As shown in FIG. 2C, after transmission of the feedback to the multimedia host, the multimedia content has been resumed automatically. Therefore, the element 205′ has changed back into element 205 that allows the user to pause the multimedia content.

As indicated above, FIGS. 2A-2C are provided as an example. Other examples may differ from what is described with regard to FIGS. 2A-2C. For example, the element 203a and/or the element 203b may be omitted in other examples. Additionally, or alternatively, the user may drag-and-drop onto the frame 201 to trigger input element 209 rather than left-clicking or right-clicking. Additionally, or alternatively, the multimedia content may continue playing while the user provides the feedback; therefore, the element 205 may remain unchanged and allow the user to pause the multimedia content (e.g., while providing the feedback).

FIG. 3 is a diagram of an example environment 300 in which systems and/or methods described herein may be implemented. As shown in FIG. 3, environment 300 may include a multimedia host 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an ML host 340, an administrator device 350, and/or a ticket system 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the multimedia host 301 may include one or more elements 303-312 of the cloud computing system 302, may execute within the cloud computing system 302, and/or may be hosted within the cloud computing system 302, in some implementations, the multimedia host 301 may not be cloud-based (e.g., may be implemented outside of a cloud computing system) or may be partially cloud-based. For example, the multimedia host 301 may include one or more devices that are not part of the cloud computing system 302, such as device 400 of FIG. 4, which may include a standalone server or another type of computing device. The multimedia host 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with multimedia content, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The ML host 340 may include one or more devices capable of receiving, generating, storing, processing, and/or providing information associated with machine learning models, as described elsewhere herein. The ML host 340 may include a communication device and/or a computing device. For example, the ML host 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 340 may communicate with one or more other devices of environment 300, as described elsewhere herein.

The administrator device 350 may include one or more devices capable of receiving, generating, storing, processing, and/or providing information associated with multimedia content, as described elsewhere herein. The administrator device 350 may include a communication device and/or a computing device. For example, the administrator device 350 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 350 may communicate with one or more other devices of environment 300, as described elsewhere herein.

The ticket system 360 may include one or more devices capable of receiving, generating, storing, processing, and/or providing information associated with tickets, as described elsewhere herein. The ticket system 360 may include a communication device and/or a computing device. For example, the ticket system 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ticket system 360 may include an issue tracking system, such as Jira® or Bugzilla®, among other examples. The ticket system 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with feedback to improve multimedia content. The device 400 may correspond to a user device 330, an ML host 340, an administrator device 350, and/or a ticket system 360. In some implementations, a user device 330, an ML host 340, an administrator device 350, and/or a ticket system 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

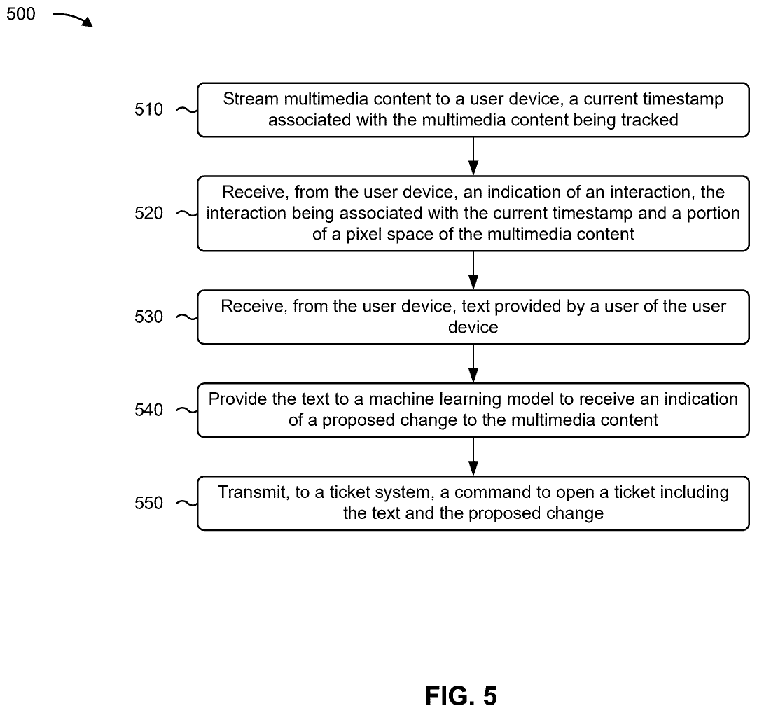

FIG. 5 is a flowchart of an example process 500 associated with feedback to improve multimedia content. In some implementations, one or more process blocks of FIG. 5 may be performed by a multimedia host 301. In some implementations, one or more process blocks of FIG. 5 may be performed by another device or a group of devices separate from or including the multimedia host 301, such as a user device 330, an ML host 340, an administrator device 350, and/or a ticket system 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include streaming the multimedia content to a user device, a current timestamp associated with the multimedia content being tracked (block 510). For example, the multimedia host 301 (e.g., using processor 420, memory 430, and/or communication component 460) may stream the multimedia content to a user device, a current timestamp associated with the multimedia content being tracked, as described above in connection with reference number 110 of FIG. 1A. As an example, the multimedia host 301 may stream the multimedia content in response to a request from the user device. In some implementations, the multimedia host 301 may use an RTSP, an RTP, and/or an RTCP to stream the multimedia content. Other protocols may include a TCP and/or an RTMP, among other examples.

As further shown in FIG. 5, process 500 may include receiving, from the user device, an indication of an interaction, the interaction being associated with the current timestamp and a portion of a pixel space of the multimedia content (block 520). For example, the multimedia host 301 (e.g., using processor 420, memory 430, and/or communication component 460) may receive, from the user device, an indication of an interaction, the interaction being associated with the current timestamp and a portion of a pixel space of the multimedia content, as described above in connection with reference number 135a of FIG. 1C. As an example, the multimedia host 301 may receive a message, such as a control message, including the indication. The indication may encode the current timestamp and may indicate the portion of the pixel space of the multimedia content.

As further shown in FIG. 5, process 500 may include receiving, from the user device, text provided by a user of the user device (block 530). For example, the multimedia host 301 (e.g., using processor 420, memory 430, and/or communication component 460) may receive, from the user device, text provided by a user of the user device, as described above in connection with reference number 135b of FIG. 1C. As an example, the text may be included in a same message as the indication of the interaction. Alternatively, the text may be included in a separate message.

As further shown in FIG. 5, process 500 may include providing the text to a machine learning model to receive an indication of a proposed change to the multimedia content (block 540). For example, the multimedia host 301 (e.g., using processor 420, memory 430, and/or communication component 460) may provide the text to a machine learning model to receive an indication of a proposed change to the multimedia content, as described above in connection with reference number 145 of FIG. 1D. As an example, the multimedia host 301 may transmit a request including the text to an ML host that provides the machine learning model. The multimedia host 301 may receive, from the ML host, the proposed change including a suggested visual, textual, and/or audio change to a particular frame (or set of frames) of the multimedia content (e.g., based on similar feedback consumed by the machine learning model).

As further shown in FIG. 5, process 500 may include transmitting, to a ticket system, a command to open a ticket including the text and the proposed change (block 550). For example, the multimedia host 301 (e.g., using processor 420, memory 430, and/or communication component 460) may transmit, to a ticket system, a command to open a ticket including the text and the proposed change, as described above in connection with reference number 160a of FIG. 1E. The ticket may further be associated with the multimedia content (e.g., indicating the multimedia content via a title and/or another type of identifier).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1G and/or FIGS. 2A-2C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

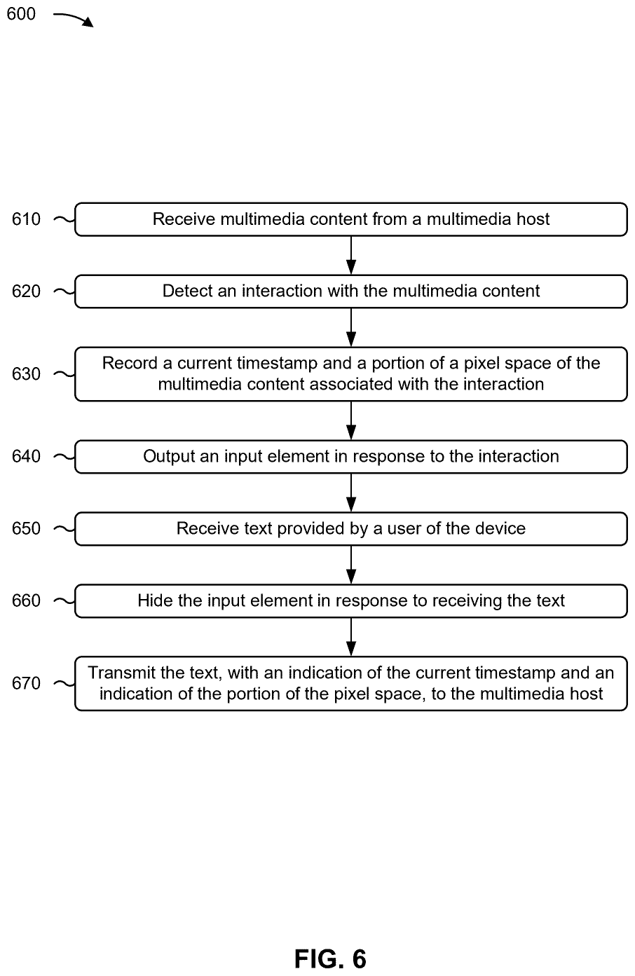

FIG. 6 is a flowchart of an example process 600 associated with feedback to improve multimedia content. In some implementations, one or more process blocks of FIG. 6 may be performed by a user device 330. In some implementations, one or more process blocks of FIG. 6 may be performed by another device or a group of devices separate from or including the user device 330, such as a multimedia host 301, an ML host 340, an administrator device 350, and/or a ticket system 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving the multimedia content from a multimedia host (block 610). For example, the user device 330 (e.g., using processor 420, memory 430, and/or communication component 460) may receive the multimedia content from a multimedia host, as described above in connection with reference number 110 of FIG. 1A. As an example, the user device 330 may transmit a request for the multimedia content and may receive the multimedia content in response to the request. In some implementations, the user device 330 may use an RTSP, an RTP, and/or an RTCP to receive the multimedia content. Other protocols may include a TCP and/or an RTMP, among other examples.

As further shown in FIG. 6, process 600 may include detecting an interaction with the multimedia content (block 620). For example, the user device 330 (e.g., using processor 420, memory 430, and/or input component 440) may detect an interaction with the multimedia content, as described above in connection with reference number 115 of FIG. 1B. As an example, the user device 330 may detect a left-click or a right-click on a portion of a pixel space of the multimedia content (e.g., a portion of a frame of a UI including the multimedia content). Additionally, or alternatively, the user device 330 may detect a drag-and-drop onto a portion of a pixel space of the multimedia content (e.g., a portion of a frame of a UI including the multimedia content).

As further shown in FIG. 6, process 600 may include recording a current timestamp and a portion of a pixel space of the multimedia content associated with the interaction (block 630). For example, the user device 330 (e.g., using processor 420 and/or memory 430) may record a current timestamp and a portion of a pixel space of the multimedia content associated with the interaction, as described above in connection with reference number 120 of FIG. 1B. As an example, the user device 330 may record the current timestamp along with coordinates associated with the interaction (e.g., coordinates at which the user left-clicked, right-clicked, or dropped in a drag-and-drop interaction). Additionally, or alternatively, the user device 330 may record the current timestamp along with translated coordinates within the multimedia content based on coordinates associated with the interaction.

As further shown in FIG. 6, process 600 may include outputting an input element in response to the interaction (block 640). For example, the user device 330 (e.g., using processor 420, memory 430, and/or output component 450) may output an input element in response to the interaction, as described above in connection with reference number 130 of FIG. 1C. As an example, and as described in connection with FIG. 2B, the user device 330 may add the input element to a UI that includes the multimedia content. Therefore, a user of the user device may provide text using the input element.

As further shown in FIG. 6, process 600 may include receiving text provided by a user of the device (block 650). For example, the user device 330 (e.g., using processor 420, memory 430, and/or input component 440) may receive text provided by a user of the device, as described above in connection with reference number 130 of FIG. 1C. As an example, the text may include feedback on the multimedia content. In particular, the text may include feedback associated with the current timestamp and the portion of the pixel space of the multimedia content.

As further shown in FIG. 6, process 600 may include hiding the input element in response to receiving the text (block 660). For example, the user device 330 (e.g., using processor 420 and/or memory 430, and/or output component 450) may hide the input element in response to receiving the text, as described above in connection with reference number 130 of FIG. 1C. As an example, and as described in connection with FIG. 2C, the user device 330 may remove the input element from the UI that includes the multimedia content.

As further shown in FIG. 6, process 600 may include transmitting the text, with an indication of the current timestamp and an indication of the portion of the pixel space, to the multimedia host (block 670). For example, the user device 330 (e.g., using processor 420, memory 430, and/or communication component 460) may transmit the text, with an indication of the current timestamp and an indication of the portion of the pixel space, to the multimedia host, as described above in connection with reference numbers 135a and 135b of FIG. 1C. As an example, the user device 330 may transmit a message, such as a control message, including the indications. The user device 330 may transmit the text in a same message as the indications or in a separate message.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1G and/or FIGS. 2A-2C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for gathering and assessing feedback on multimedia content, the system comprising:
one or more memories; and
one or more processors, communicatively coupled to the one or more memories, configured to:
stream the multimedia content to a user device, wherein a current timestamp associated with the multimedia content is tracked;
receive, from the user device, an indication of an interaction, wherein the interaction is associated with the current timestamp and a portion of a pixel space of the multimedia content;
receive, from the user device, text provided by a user of the user device;
provide the text to a machine learning model to receive an indication of a proposed change to the multimedia content; and
transmit, to a ticket system, a command to open a ticket including the text and the proposed change.

2. The system of claim 1, wherein the one or more processors are configured to:
pause streaming of the multimedia content in response to the indication of the interaction; and
resume streaming of the multimedia content in response to the text.

3. The system of claim 1, wherein the one or more processors are configured to:
continue streaming the multimedia content after receiving the indication of the interaction.

4. The system of claim 1, wherein the one or more processors are configured to:
receive, from the user device, a request for the multimedia content,
wherein the multimedia content is streamed to the user device in response to the request.

5. The system of claim 1, wherein the multimedia content comprises a current training, and wherein the one or more processors are configured to:
detect an end of a previous training,
wherein the multimedia content is streamed to the user device in response to the end of the previous training.

6. The system of claim 1, wherein the interaction comprises a left-click or a right-click on the portion of the pixel space.

7. The system of claim 1, wherein the interaction comprises a drag-and-drop onto the portion of the pixel space.

8. A method of gathering and assessing feedback on multimedia content, comprising:
streaming, from a multimedia host and to a user device, the multimedia content, wherein a current timestamp associated with the multimedia content is tracked;
receiving, at the multimedia host and from the user device, an indication of an interaction, wherein the interaction is associated with the current timestamp and a portion of a pixel space of the multimedia content;
receiving, at the multimedia host and from the user device, text provided by a user of the user device;
providing, by the multimedia host, the text to a machine learning model to cluster the text with additional feedback provided by one or more additional users; and
transmitting, from the multimedia host and to an administrator device, an indication of the text and the additional feedback.

9. The method of claim Error! Reference source not found., wherein the machine learning model clusters the text based on sentiment.

10. The method of claim Error! Reference source not found., wherein the machine learning model clusters the text based on content.

11. The method of claim Error! Reference source not found., further comprising:
providing the text to an additional machine learning model to receive an indication of a proposed change to the multimedia content,
wherein the indication of the text and the additional feedback further indicates the proposed change.

12. The method of claim Error! Reference source not found., wherein providing the text to the machine learning model comprises:
transmitting, to a machine learning host associated with the machine learning model, the text; and
receiving, from the machine learning host, an indication of the additional feedback.

13. The method of claim Error! Reference source not found., wherein the indication of the text and the additional feedback is included in an email message.

14. A non-transitory computer-readable medium storing a set of instructions for providing feedback on multimedia content, the set of instructions comprising:
one or more instructions that, when executed by one or more processors of a device, cause the device to:
receive the multimedia content from a multimedia host;
detect an interaction with the multimedia content;
record a current timestamp and a portion of a pixel space of the multimedia content associated with the interaction;
output an input element in response to the interaction;
receive text provided by a user of the device;
hide the input element in response to receiving the text; and
transmit the text, with an indication of the current timestamp and an indication of the portion of the pixel space, to the multimedia host.

15. The non-transitory computer-readable medium of claim Error! Reference source not found., wherein the one or more instructions, when executed by the one or more processors, cause the device to:
pause output of the multimedia content in response to detecting the interaction; and
resume output of the multimedia content in response to receiving the text.

16. The non-transitory computer-readable medium of claim Error! Reference source not found., wherein the one or more instructions, when executed by the one or more processors, cause the device to:
continue outputting the multimedia content after detecting the interaction.

17. The non-transitory computer-readable medium of claim Error! Reference source not found., wherein the one or more instructions, when executed by the one or more processors, cause the device to:
output the multimedia content to a user interface (UI) that includes a frame for the multimedia content.

18. The non-transitory computer-readable medium of claim 17, wherein the one or more instructions, that cause the device to output the input element, cause the device to:
add the input element to the UI.

19. The non-transitory computer-readable medium of claim 17, wherein the one or more instructions, that cause the device to hide the input element, cause the device to:
remove the input element from the UI.

20. The non-transitory computer-readable medium of claim Error! Reference source not found., wherein the input element comprises a text box.
